(19) United States
(12) Patent Application Publication
(10) Pub. No.: US 2008/0288239 A1
(43) Pub. Date: Nov. 20, 2008

(54) Localization and internationalization of document resources

(75) Inventors: Eric D. Bailey, Redmond, WA (US); Roberto C. Taboada, Duvall, WA (US); Alfred Hellstern, Redmond, WA (US); William C. Henry, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/803,691

(22) Filed: May 15, 2007

(51) Int. Cl. G06F 17/28

(52) U.S. Cl. 704/2

(57) ABSTRACT

Automated localization (translation) and internationalization of document resources may be provided for use by various target user groups requiring different text languages and/or document settings. A document resource including pre-built textual components and document settings and properties is first passed through a translation process for translating any pre-built textual content to one or more target languages. Text strings in the document resource may be extracted, translated and replaced to the document resource. Internationalization processing may then be accomplished wherein default page sizes, margin settings, language reading direction, and other document settings and properties are modified according to each target user group for the document resource. For initial document resource assembly, source files are identified for each component of a given document resource. The source files may be localized and internationalized and then may be used to compile a document resource for each of one or more target user groups.

### BACKGROUND OF THE INVENTION

Modern software applications provide rich content that may be applied to documents to provide a variety of useful properties to the documents. Document templates are often provided that include rich context-based content that may be applied to various parts of the document, such as pre-built headings, section titles, footers, and the like. For example, a memorandum template may be shipped with an associated software application, and the memorandum template may have various sections containing pre-formatted footers, headers, section titles, and the like containing pre-formatted textual information and formatting properties. In addition, some software applications are shipped with collections of selectable document components, for example, cover pages, document headers, footers, sections, and the like that may be applied to a user document or that may be used in a document template.

When such documents and/or document components are made available to user groups of different languages and cultures, the documents and document components must be localized (translated to each target language) and must be internationalized to the standard document settings and properties of each target user group. Such localization and internationalization is typically a manual process and takes a great deal of time and quality review, particularly for documents and document components made available to numerous target user groups. For example, all pre-built textual information must be translated to target languages and document properties, for example, page size, margin settings and reading direction, must be adjusted for each target user group. In addition, assembling various components of document templates, for example, resume templates, memorandum templates, report templates, etc. is a tedious and time-consuming process when each document template must be localized and internationalized for use by a number of target user groups of different languages and cultures.

It is with respect to these and other considerations that the present invention has been made.

### SUMMARY OF THE INVENTION

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing automated localization (translation) and internationalization of documents and document components for use by various target user groups requiring different text languages and/or document settings. According to an embodiment, a document including pre-built textual components and document settings and properties is first passed through a document translation process for translating any pre-built textual content to a language suitable for one or more target user groups. In the translation process, all text strings contained in the document may be extracted, translated and then may be replaced to the document or document template. Internationalization processing may then be accomplished wherein default page sizes, margin settings, language reading direction, and other document settings and properties are modified according to each target user group for the document or document template.

For initial assembly of a document template, source files are identified for each component of a given document template. The source files are passed through the translation and internationalization process described above. A desired document template is then compiled by assembling source files that have been localized and internationalized into the desired document template. For each document template, default template components, for example, cover pages, headers, footers, and the like may be applied to the template. The template then may be stored for additional use.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a simplified block diagram illustrating a system architecture for localization and internationalization of documents and document components.

FIG. 2 is a logical flow diagram illustrating a method of localizing and internationalizing documents and document components.

FIG. 3 is a logical flow diagram illustrating a method of assembling localized and internationalized document templates.

FIG. 4 is a simplified block diagram illustrating an example computing operating environment in which embodiments of the invention may be practiced.

### DETAILED DESCRIPTION

As briefly described above, embodiments of the present invention are directed to automated localization and internationalization of documents and document components for use according to different languages, document styles and settings associated with users of different languages and cultures. The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

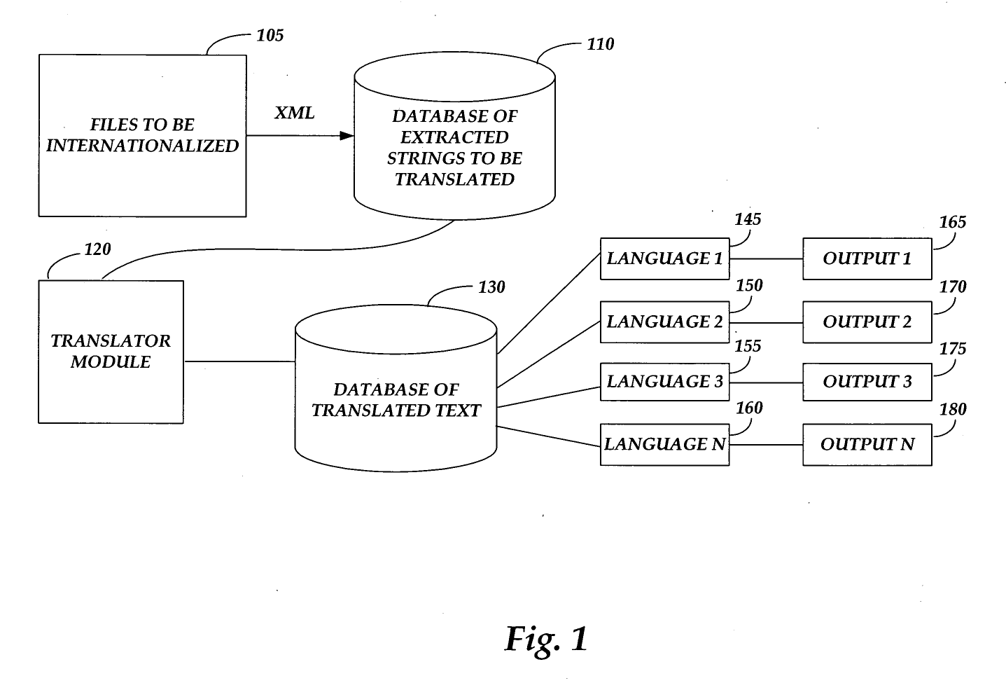

FIG. 1 is a simplified block diagram illustrating an architecture for a localization and internationalization system 100. According to an embodiment, the localization and internationalization system 100 is operative to convert one or more document templates or document components (hereafter referred to as document resources) configured and formatted for use by a first spoken language and cultural user group into a second format for use by a different spoken language and cultural user group. For example, a document resource processed by the system 100 may contain textual information entered and displayed in English and applied document settings and properties, for example, page size, margin settings, reading direction, and the like associated with a particular English speaking cultural group, for example, English speaking Americans. According to embodiments of the present invention, such a document resource may be processed by the system 100 so that English language text strings in the document resource are automatically translated to a target language, for example, Spanish, and document properties applied to the document resource may be converted to those properties applicable to readers in Spain. For example, the language for the document resource may be converted from English to Spanish, page size for the document resource may be converted from 8.5 inches by 11.0 inches to the A4 paper size used by many European document users, and margin sizes of 1.0 inches may be converted to 2.5 cm.

According to one embodiment, a software application, for example, a word processing application, a slide presentation application, a spreadsheet application, a desktop publishing application and the like may be populated with or have access to a collection of document resources. For example, a word processing application may have a collection of document templates from which a user may select from one of many document templates associated with a given subject. For example, a first collection of document templates may be associated with letter preparation and may include a number of letter templates for selection by a given user. A letter template may be formatted in a right and left side justification and may have addresser and addressee information oriented along the left side of the page. In addition, the example letter template may be directed to users who read in a left to right orientation. Other documents may be included in the letter document collection including cover page documents, letter attachment document templates and the like. Other collections of document templates may include one or more document templates for the creation of memoranda, reports, manuscripts, and the like.

As should be appreciated, document templates contained in such collections of document templates may have a variety of pre-formatted and pre-packaged textual information, as well as, non-textual content, such as pictures, text boxes, etc. For example, a resume template may include a heading for personal information, a heading for educational information, a heading for work experience, and a heading for hobbies and special interests. Each heading may be formatted with a given font size, font type and coloring.

In addition, document resource collections may include components of documents or document templates. For example, one collection may include a number of heading components, another collection may include a number of footer components, another collection may include a number of news article components, and the like. Indeed, as should be appreciated, any portion of a document that may be used on a frequent basis may be pre-formatted to include textual information and formatting associated with a given language and cultural group for use by users in preparing associated documents.

As should be appreciated, when a developer of a software application that provides pre-built document resources, as described above, must configure the application for use by different language and cultural groups, the task of localizing (translating) textual information contained in such document resources and internationalizing document settings and properties available across the entirety of a given software application or suite of software applications is an arduous task. First, all textual information contained in such document resources must be translated to each language associated with a given language and/or cultural group that may use the software application. Second, document settings and properties, such as the aforementioned page sizes, margin settings and reading orientation, must be changed for each document resource for each target user group.

Referring still to FIG. 1, the localization and internationalization system 100 includes a set of files 105 that require localization and internationalization according to embodiments of the present invention. The files 105 may include one or more document resources associated with a given software application, or the files 105 may include a collection of document resources, as described above, that require localization and internationalization for use by a target user group (group with specified reading languages and/or document settings and properties).

According to one embodiment, each of the files assembled for processing may be converted into a format such as the Extensible Markup Language (XML) format that makes processing data associated with the files easier and more efficient. For example, as is well known to those skilled in the art, XML is a self-defining markup language that allows each component of a document including content and formatting to be tagged with an XML tag that may be defined by an associated XML schema. Subsequently, an XML parser may be used for parsing the XML formatted document resources for locating information that needs to be localized or internationalized for a given target user group. As should be appreciated, if document resources are not formatted according to a markup language, such as XML, other mechanisms may be utilized for extracting text strings and document properties from the associated files. For example, a document object model (DOM) associated with a software application with which a given document is prepared and/or used may be utilized for extracting text strings and document properties and settings from an associated document resource.

According to an embodiment of the present invention, text strings contained in the files 105 are extracted, as described above, and are stored in a database of extracted strings to be translated 110. A translator module 120 is operative to translate each of the extracted text strings stored in the database 110 from a starting language to a target language. For example, each text string extracted from the database 110 may be translated from English to Spanish, English to French, English to Russian, English to Chinese, English to Japanese, and the like. After the extracted text strings are translated for each target language, the translated text strings are stored to a database of translated text 130. The translated text strings are then injected from the database 130 into document resources 145, 150, 155, 160 associated with each target language group. For example, the language document 145 may be a document template that will be used by Spanish-speaking users in Spain. Thus, the document template may be populated with text strings translated from English to Spanish. For another example, the language document 155 may be populated with text strings translated from English to Arabic for use by Arabic-speaking users.

After each document resource 145-160 is populated with text strings translated or localized according to various target language groups, each document resource 145-160 may be passed through an internationalization process where document settings and properties associated with each document resource are converted from a first set of document settings and properties to a second set of document settings and properties appropriate for the target user group. For example, the document resource 145 wherein text strings have been translated from English to Spanish may be internationalized for use by document users in Spain where a standard page size for the document template will be converted from 8.5 inches by 11.0 inches used in an English-speaking American culture to the A4 page size used most often by document users in Spain. In addition, a standard margin setting applied to the document for English-speaking American users of 1.0 inches along a left side of the page may be converted to 2.5 cm for the Spanish user group. For another example, the document resource 155 wherein English language text strings are converted to Arabic language text strings may be passed through the internationalization process as described for the Spanish document resource 155, but in addition, a document setting that converts the reading orientation for the associated document resources to a right-to-left reading orientation typically used by Arabic language and/or cultural groups may be applied to the document resources to properly internationalize them for the Arabic language and/or cultural users groups.

As should be appreciated, the process by which each document resource is internationalized, as described herein, is similar to the process by which text strings contained in each document resource are translated or localized. For example, a parser associated with each target user group may parse the document resources to locate tagged document properties and settings and to replace those document properties and settings with the appropriate document properties and settings required for the target user group. As should be appreciated, the process of translating text strings for each document resource and the process of internationalizing each document resource may be reversed. That is, the document resources may first be internationalized for the target user group followed by translation of text strings pre-populated into each document resource.

After each document resource has been localized (translated) and internationalized for a desired target user group, the processed document resource is saved for subsequent use. Referring to FIG. 1, each output document 165-180 is illustrative of localized and/or internationalized document resources that are ready for use by each respective target user group.

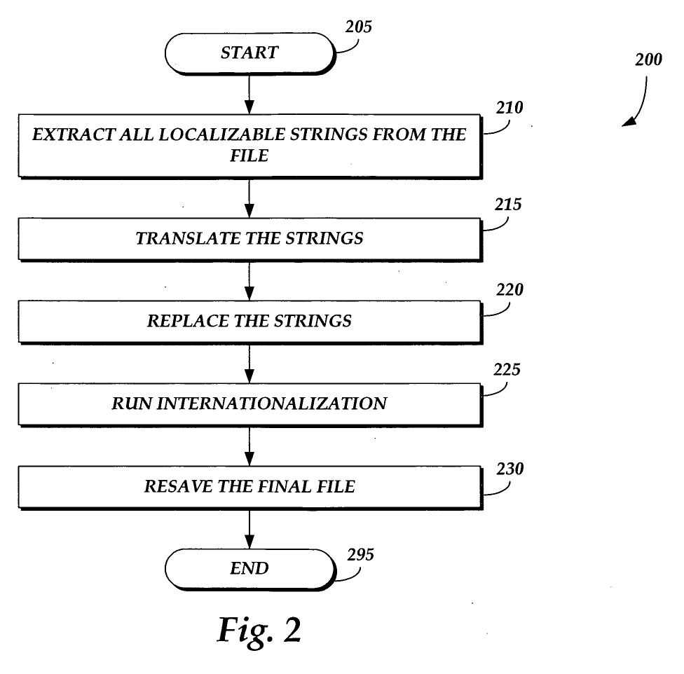

FIG. 2 is a logical flow diagram illustrating a method for localizing and/or internationalizing a document resource according to the system 100, described above. The localization and internationalization method begins at start operation 205 and proceeds to operation 210 where all localizable or translatable text strings are extracted from a subject document resource for translation. The extracted text strings are passed to the translator module 120 for translation from a starting language to a desired target language. At operation 220, the translated or localized text strings are injected from database 130 into an instance 145-160 of the document resource for each target user group according to the required language. At operation 225, internationalization processing is performed, as described above with reference to FIG. 1, for each instance of the document resource for each target user group to populate each document resource instance with document properties and document settings associated with a target user group, for example, Spanish-speaking cultures, etc. At operation 230, the localized and internationalized document resource instances are saved as document resources 165-180 for subsequent use by each respective target user group.

According to one embodiment, the localization and internationalization processes described herein may be performed at both a document level and at a file format level. For example, each document resource may be parsed for text strings and document properties and settings for conversion as described above. On the other hand, if a given document resource is formatted according to a formatting type that allows document editing at a file format level, such as the Extensible Markup Language format described above, a parser operative to parse the document at a file format level may be utilized for finding those particular items, for example, text strings, document properties and document settings, that require conversion, and the parsing application may automatically convert items parsed from formatted files for automatically converting the document resource for use by a target user group. The method ends at operation 295.

According to another embodiment of the invention, the localization and internationalization system 100 may be utilized for generating and assembling a document resource according to a variety of target user groups. For example, it may be desired by a document developer to create a document template where each section of the document template may include a collection of selectable document components according to one or more target languages and according to one or more target document settings and styles. For example, a document template for a resume document may include a menu (or collection) of document components for each section. For example, a collection of document components may be provided for the education section of a resume template that allows a user to select from a collection of pre-formatted education section components. For example, a first education section component may be pre-formatted for receiving three education items and may be pre-formatted for presentation according to specified font types, font sizes, text coloring, and the like. Another collection of document components may be available for the work experience section of the resume document template that may offer similar pre-formatted document properties and settings for introducing work experience information into the example resume template.

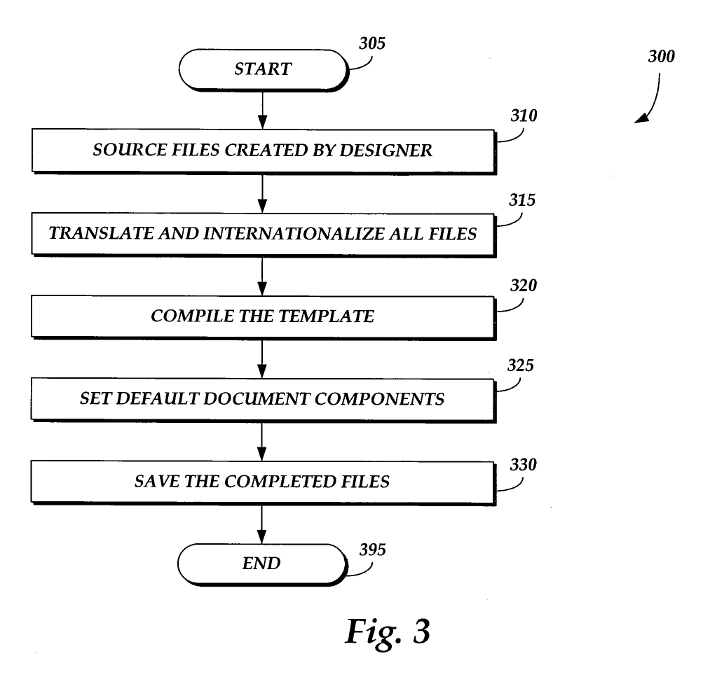

According to embodiments of the present invention, the localization and internationalization system 100 may be utilized for generating such a document resources and for translating text files associated with each document component that may be utilized in the document resources and for internationalizing each document component to conform to document settings and properties associated with a given target user group. FIG. 3 is a logical flow diagram illustrating a method for assembling localized and internationalized document resources. The document resource assembly method 300 begins at start operation 305 and proceeds to operation 310. At operation 310, a starting document resource that may contain only a body portion and certain document styles is obtained as a “blank slate” for applying localized and internationalized document components.

At operation 310, source files created by a document developer that include each potential document component for display in the various collections of document components, for example, each potential component of a work experience section of a resume document template, are obtained for localization and internationalization, as described herein. At operation 315, each text string contained in each document component that may be included in the document resource or in a collection of document components is extracted and is passed through the translation module 120 for translation, as described above with reference to FIGS. 1 and 2. After the text strings extracted from each document component are translated for each target user group, the translated text strings are injected back into an instance of each associated document component for ultimate use in a collection of document components or a document template associated with a given target user group, for example, French users. After translation processing, each document component is then internationalized, as described above with reference to FIGS. 1 and 2 such that the document settings and properties for each document component are internationalized to conform to the document settings and properties required for each target user group.

At operation 320, the document resource to be generated according to the method 300 is compiled to include one or more required document components and to point to or to include one or more collections of selectable document components where each document component pre-populated into the template or available to the template via a collection of document components has been localized (translated) and internationalized according to a given user group. The compilation of document components may include localized and internationalized textual components and may include one or more non-textual components, for example, pictures, text boxes, etc. designed for the document resource by a developer/designer of the resource. Thus, a document resource is compiled for each target user group, for example, Spanish users, French users, English users, Russian users, Japanese users, etc.

At operation 325, any default document components required for a given document resource are set for the document resource. For example, if a given document template, for example, a resume document template is pre-populated with at least a name section, personal information section, education experience section, and work experience section, then document components for each of these sections are set to the compiled document template by default. Any collections of selectable document components are also set to the document resource for allowing a subsequent user to add additional document components to the compiled document resource as desired. At operation 330, the compiled document resources for each target user group are saved for subsequent offering via associated software applications. The method 300 ends at operation 395.

### Operating Environment

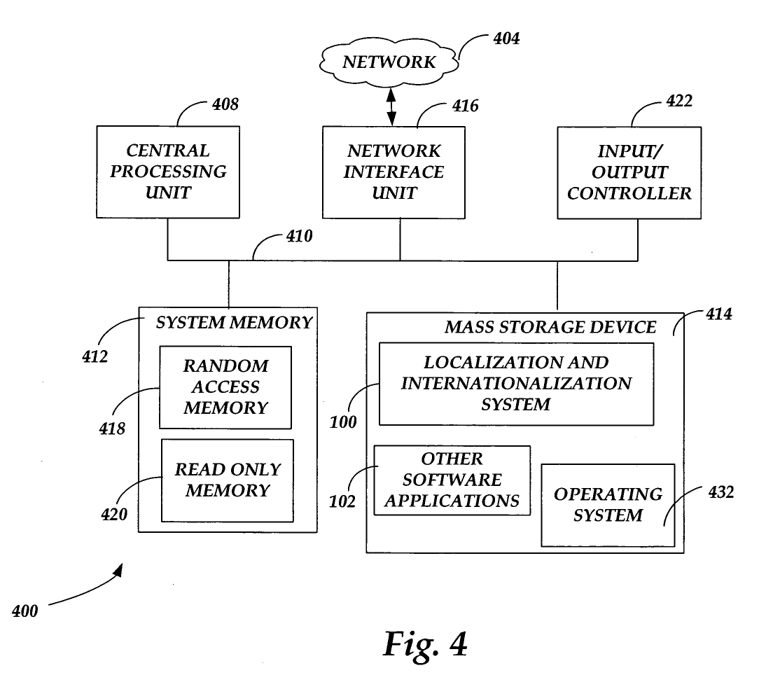

Referring now to FIG. 4, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 4, an illustrative operating environment for embodiments of the invention will be described. As shown in FIG. 4, computer 400 comprises a general purpose desktop, laptop, handheld, mobile or other type of computer (computing device) capable of executing one or more application programs. The computer 400 includes at least one central processing unit 408 (“CPU”), a system memory 412, including a random access memory 418 (“RAM”) and a read-only memory (“ROM”) 420, and a system bus 410 that couples the memory to the CPU 408. A basic input/output system containing the basic routines that help to transfer information between elements within the computer, such as during startup, is stored in the ROM 420. The computer 402 further includes a mass storage device 414 for storing an operating system 432, application programs, and other program modules.

The mass storage device 414 is connected to the CPU 408 through a mass storage controller (not shown) connected to the bus 410. The mass storage device 414 and its associated computer-readable media provide non-volatile storage for the computer 400. Although the description of computer-readable media contained herein refers to a mass storage device, such as a hard disk or CD-ROM drive, it should be appreciated by those skilled in the art that computer-readable media can be any available media that can be accessed or utilized by the computer 400.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 400.

According to various embodiments of the invention, the computer 400 may operate in a networked environment using logical connections to remote computers through a network 404, such as a local network, the Internet, etc. for example. The computer 402 may connect to the network 404 through a network interface unit 416 connected to the bus 410. It should be appreciated that the network interface unit 416 may also be utilized to connect to other types of networks and remote computing systems. The computer 400 may also include an input/output controller 422 for receiving and processing input from a number of other devices, including a keyboard, mouse, etc. (not shown). Similarly, an input/output controller 422 may provide output to a display screen, a printer, or other type of output device.

As mentioned briefly above, a number of program modules and data files may be stored in the mass storage device 414 and RAM 418 of the computer 400, including an operating system 432 suitable for controlling the operation of a networked personal computer, such as the WINDOWS® operating systems from MICROSOFT CORPORATION of Redmond, Wash. The mass storage device 414 and RAM 418 may also store one or more program modules. In particular, the mass storage device 414 and the RAM 418 may store application programs, such as a software application 424, for example, a word processing application, a spreadsheet application, a slide presentation application, a database application, etc.

According to embodiments of the present invention, a localization and internationalization system 100 is illustrated with which a document resource may be localized and internationalized for a target user group as described herein. According one embodiment, all components of the system 100 may be operated as an integrated system stored and operated from a single computing device 400. Alternatively, one or more components of the system 100 may be stored and operated at different computing devices 400 that communicate with each other via a distributed computing environment. Software applications 102 are illustrative of software applications operative to provide document resources that may require localization and internationalization by the system 100, described herein. Examples of software applications 102 include, but are not limited to, word processing applications, slide presentation applications, spreadsheet applications, desktop publishing applications, and any other application providing one or more user interface components that may require testing and analysis.

It should be appreciated that various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

As described herein, methods and systems are described for automatically localizing and internationalizing document resources for use by one or more target user groups. Although the invention has been described in connection with various embodiments, those of ordinary skill in the art will understand that many modifications may be made thereto within the scope of the claims that follow. Accordingly, it is not intended that the scope of the invention in any way be limited by the above description, but instead be determined entirely by reference to the claims that follow.

We claim:

1. A method of automatically localizing and internationalizing a document resource for use by a target user group, comprising:
receiving a document resource containing textual content rendered according to a first spoken language utilized by a first document user group and containing one or more document settings utilized by the first document user group;
translating the textual content contained in the document resource from the first spoken language to a second spoken language utilized by a second document user group; and
modifying the one or more document settings from document settings utilized by the first document user group to document settings utilized by the second document user group.

2. The method of claim 1, wherein receiving a document resource containing textual content rendered according to a first spoken language utilized by a first document user group and containing one or more document settings utilized by the first document user group, includes receiving one or more components of a document template containing content rendered according to the first spoken language and the one or more components containing one or more document settings utilized by the first document user group, the one or more components being components available for compilation of the document template.

3. The method of claim 2, wherein receiving the one or more components of the document template, includes receiving the one or more components from a collection of components from which a given component may be selectively applied to the document template.

4. The method of claim 1, prior to translating the textual content contained in the document resource from the first spoken language to a second spoken language utilized by a second document user group, further comprising:
parsing the received document resource for textual content contained in the document resource;
extracting the textual content from the document resource; and
storing the extracted textual content for translation from the first spoken language to a second spoken language utilized by a second document user group.

5. The method of claim 4, further comprising passing the stored textual content to a translation processor for translating the textual content from the first spoken language to a second spoken language utilized by a second document user group.

6. The method of claim 5, after translating the textual content contained in the document resource from the first spoken language to a second spoken language utilized by a second document user group, injecting the translated textual content into an instance of the document resource associated with the second document user group.

7. The method of claim 6, wherein modifying the one or more document settings from document settings utilized by the first document user group to document settings utilized by the second document user group includes modifying the one or more document settings in the instance of the document resource associated with the second document user group so that the instance of the document resource contains textual content translated to a second spoken language utilized by a second document user group and one or more document settings utilized by the second document user group.

8. The method of claim 7, further comprising saving the instance of the document resource that contains textual content translated to a second spoken language utilized by a second document user group and one or more document settings utilized by the second document user group as a second document resource associated with the second document user group.

9. A method of assembling a document resource for use by a target user group, comprising:
receiving a document template for housing one or more pre-built document components containing textual content rendered according to a first spoken language utilized by a first document user group and containing one or more document settings utilized by the first document user group;
receiving one or more document components for integrating with the document template as the one or more pre-built document templates, the one or more document components containing textual content rendered according to a first spoken language utilized by a first document user group and containing one or more document settings utilized by the first document user group;
translating the textual content contained in the one or more document components from the first spoken language to a second spoken language utilized by a second document user group;
modifying the one or more document settings from document settings utilized by the first document user group to document settings utilized by the second document user group; and
providing the one or more document components containing the translated textual content and the modified one or more document settings to the document template for compiling a second document template for use by the second document user group.

10. The method of claim 9, wherein providing the one or more document components containing the translated textual content and the modified one or more document settings to the document template for compiling a second document template for use by the second document user group includes providing the one or more document components in a collection of selectable document components from which one or more of the one or more document components may be selectively added to the document template.

11. The method of claim 9, wherein receiving one or more document components for integrating with the document template as the one or more pre-built document templates includes receiving the one or more document components from a collection of document components from which a given component may be selectively added to the document template.

12. The method of claim 9, prior to translating the textual content contained in the one or more document components from the first spoken language to a second spoken language utilized by a second document user group, further comprising:
parsing the received one or more document components for integrating with the document template for textual content contained in the one or more document components;
extracting the textual content from the one or more document components; and
storing the extracted textual content for translation from the first spoken language to a second spoken language utilized by a second document user group.

13. The method of claim 12, further comprising passing the stored textual content to a translation processor for translating the textual content from the first spoken language to a second spoken language utilized by a second document user group.

14. The method of claim 13, after translating the textual content contained in the one or more document components from the first spoken language to a second spoken language utilized by a second document user group, injecting the translated textual content into an instance of each of the one or more document components associated with the second document user group.

15. The method of claim 14, modifying the one or more document settings from document settings utilized by the first document user group to document settings utilized by the second document user group includes modifying the one or more document settings in the instance of each of the one or more document components associated with the second document user group so that the instance of each of the one or more document components associated with the second document user group contains textual content translated to a second spoken language utilized by a second document user group and one or more document settings utilized by the second document user group.

16. The method of claim 15, further comprising saving the instance of each of the one or more document components associated with the second document user group that contains textual content translated to a second spoken language utilized by a second document user group and one or more document settings utilized by the second document user group.

17. A computer-readable medium containing computer executable instructions which when executed perform a method of automatically localizing and internationalizing a document template for use by a target user group, comprising:
receiving one or more components of a document template containing textual content rendered according to the first spoken language and the one or more components containing one or more document settings utilized by the first document user group, the one or more components being components available for compilation of the document template;
translating the textual content contained in the one or more components of the document template from the first spoken language to a second spoken language utilized by a second document user group; and
modifying the one or more document settings from document settings utilized by the first document user group to document settings utilized by the second document user group.

18. The computer readable medium of claim 17, prior to translating the textual content contained in the one or more components of the document template from the first spoken language to a second spoken language utilized by a second document user group, further comprising:
parsing the received one or more document components for textual content contained in the one or more document components;
extracting the textual content from the one or more document components; and
storing the extracted textual content for translation from the first spoken language to a second spoken language utilized by a second document user group.

19. The computer-readable medium of claim 18, after translating the textual content contained in the one or more document components from the first spoken language to a second spoken language utilized by a second document user group, injecting the translated textual content into an instance of each of the one or more document components associated with the second document user group.

20. The computer-readable medium of claim 19, wherein modifying the one or more document settings from document settings utilized by the first document user group to document settings utilized by the second document user group includes modifying the one or more document settings in the instance of each of the one or more document components associated with the second document user group so that the instance of each of the one or more document components contains textual content translated to a second spoken language utilized by a second document user group and one or more document settings utilized by the second document user group.
